(19) United States
(12) Patent Application Publication
(10) Pub. No.: US 2026/0048617 A1
(43) Pub. Date: Feb. 19, 2026

(54) NON-DIRECTIONAL PNEUMATIC TIRE FOR USE ON AN AGRICULTURAL MACHINE

(71) Applicant: Lindsay Corporation, Omaha, NE (US)

(72) Inventor: Richard Provaznik, Omaha, NE (US)

(21) Appl. No.: 19/300,302

(22) Filed: Aug. 14, 2025

Related U.S. Application Data
(60) Provisional application No. 63/683,446, filed on Aug. 15, 2024.

(51) Int. Cl. B60C 11/03

(52) U.S. Cl. CPC B60C 11/0311; B60C 2200/08

(57) ABSTRACT

A non-directional pneumatic tire has a tire carcass and a non-directional tread pattern. The tire carcass has first and second sidewalls; an outer wall extending radially between the first and second sidewalls; a first transition between the first sidewall and the outer wall; and a second transition between the first sidewall and the outer wall. The first and second transitions are angular with little curvature. The outer wall of the tire carcass has a midpoint and two side edges. The outside diameter of the midpoint is only slightly greater than outside diameters of the side edges such that the outer wall is substantially flat with little curvature from the midpoint to the side edges. The tread pattern comprises a first row of longitudinal lugs; a second row of longitudinal lugs; and a plurality of mud-shedding lugs between adjacent pairs of the longitudinal lugs.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/683,446; titled “TIRE WITH FEATURES FOR IMPROVED RUTTING”; and filed Aug. 15, 2024. The Provisional Application is hereby incorporated by reference, in its entirety, into the current patent application.

### BACKGROUND OF THE INVENTION

Tires for vehicles that mostly travel in one direction (typically forward) have directional tread patterns that are optimized for a single direction of travel. If these tires are driven in the opposite direction, or if they are mounted on their wheels in the wrong direction, they may vibrate or exhibit other undesired characteristics.

Center pivot and lateral move irrigation systems and other agricultural machines regularly move in both forward and backward directions and therefore benefit from non-directional tires that have tread patterns designed to perform the same in both directions. Unfortunately, known non-directional tires suffer from several problems. For example, they often create deep ruts in the fields in which they are used and push too much mud to the sides of the ruts into rut ridges. These ruts and ridges can interfere with the travel of the irrigation systems and other vehicles traversing the fields and can accumulate water. Existing non-directional tires also suffer from excessive mud accumulation on and between their treads.

### SUMMARY OF THE INVENTION

Embodiments of the present invention solve the above-described problems and other related problems by providing an improved non-directional tire that reduces rutting depth and rut ridge height and that more effectively sheds mud from the tire.

One feature of tires constructed in accordance with embodiments of the present is a relatively flat outer radial wall with less curvature than the outer walls of prior art tires. Applicants have discovered that a flatter tire profile increases the contact area between the tire and the ground to reduce rutting and rut ridge height.

Another feature of tires constructed in accordance with embodiments of the present is sharp transitions between the tires' outer radial walls and sidewalls. In contrast, prior art tires have more significantly curved transitions. Applicant has discovered that the shaper transitions also reduce rutting depth and rut ridge heights.

Another feature of tires constructed in accordance with embodiments of the present is a non-directional tread pattern that is optimized for reducing rut depth and rut ridge height. The tread patterns also exhibit superior mud-shedding characteristics to reduce mud accumulation on the tires.

A non-directional pneumatic tire constructed in accordance with an embodiment of the present invention incorporates at least one of the above-described features. The tires has a rotational axis and a central plane extending perpendicularly through the rotational axis and comprises: a tire carcass and a non-directional tread pattern extending from the carcass. The tire carcass defines an internal inflation chamber and comprises first and second sidewalls; an outer wall extending radially between the first and second sidewalls; a first transition between the first sidewall and the outer wall; and a second transition between the first sidewall and the outer wall. In accordance with an important aspect of the invention, the first and second transitions are angular with little curvature.

A non-directional pneumatic tire constructed in accordance with another embodiment of the present invention also comprises a tire carcass and a non-directional tread pattern extending from the carcass. The tire carcass comprises first and second sidewalls; and an outer wall extending radially between the first and second sidewalls. The outer wall has a midpoint and two side edges. In accordance with an important aspect of the invention, an outside diameter of the midpoint is only slightly greater than the outside diameters of the side edges such that the outer wall is substantially flat with little curvature from the midpoint to the side edges.

A non-directional pneumatic tire constructed in accordance with yet another embodiment of the present invention also comprises a tire carcass and a non-directional tread pattern extending from the carcass. The tread pattern comprises: a first row of longitudinal lugs extending substantially parallel to the rotational axis of the tire from the first sidewall and toward and across the central plane of the tire; a second row of longitudinal lugs extending substantially parallel to the rotational axis of the tire from the second sidewall and toward and across the central plane of the tire; the first and second rows of longitudinal lugs circumferentially alternating so as not to touch one another; and a plurality of mud-shedding lugs between at least one adjacent pair of the lugs in the first or second rows of longitudinal lugs and extending substantially perpendicular to the rotational axis of the tire.

Tires constructed in accordance with these and other embodiments of the invention increase tire ground contact area, keep more mud within a wheel track, reduce rutting depth, reduce rut ridge heights, and provide other related advantages.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a perspective view of a non-directional tire constructed in accordance with embodiments of the present invention.

FIG. 2 is a top view of the tire.

FIG. 3 is a side view of the tire.

FIG. 4 is a sectional view of the tire taken along 4/4 of FIG. 3.

FIG. 5 is a section view of the tire taken along 5/5 of FIG. 3

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

Turning now to the drawing figures, non-directional pneumatic tires constructed in accordance with embodiments of the invention are illustrated. The tires are especially suited for use with center pivot or lateral move irrigation systems, but they may also be used with other agricultural and non-agricultural machines and vehicles that benefit from non-directional tires.

As explained in more detail below, tires constructed in accordance with embodiments of the present invention have several unique features that individually and in combination improve their performance in agricultural fields and other off-road environments. Specifically, the tires have relatively flat outer radial walls with little curvature; sharp transitions between the tires' outer radial walls and sidewalls; and tread patterns optimized for non-directional travel and mud-shedding. These features and other aspects of the tires increase tire ground contact area, keep more mud within a wheel track, reduce rutting depth, reduce rut ridge heights, reduce mud accumulation on the tires, and provide other related advantages.

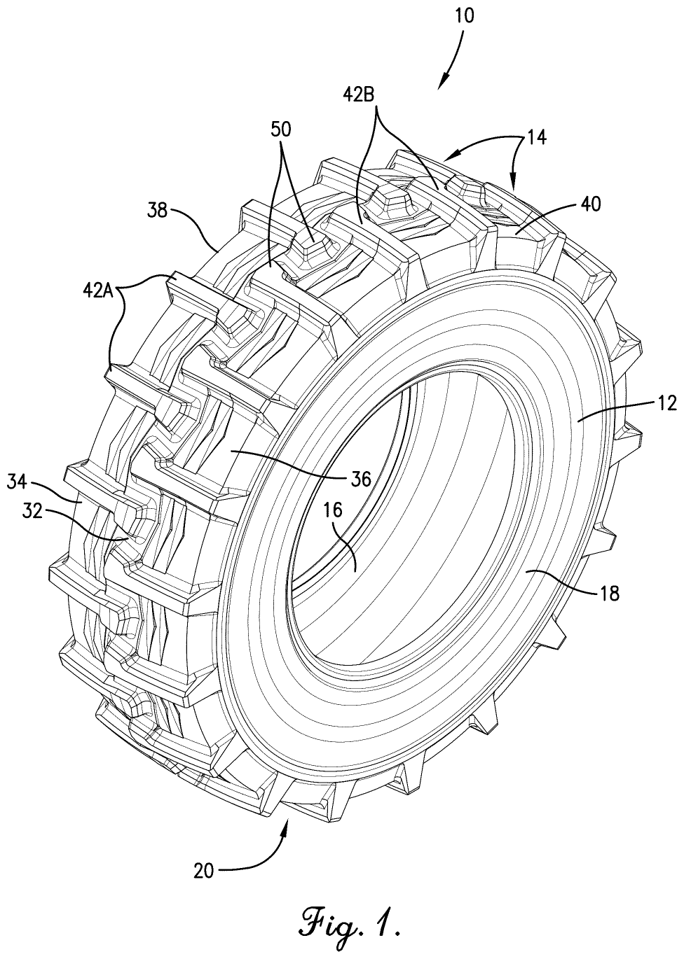

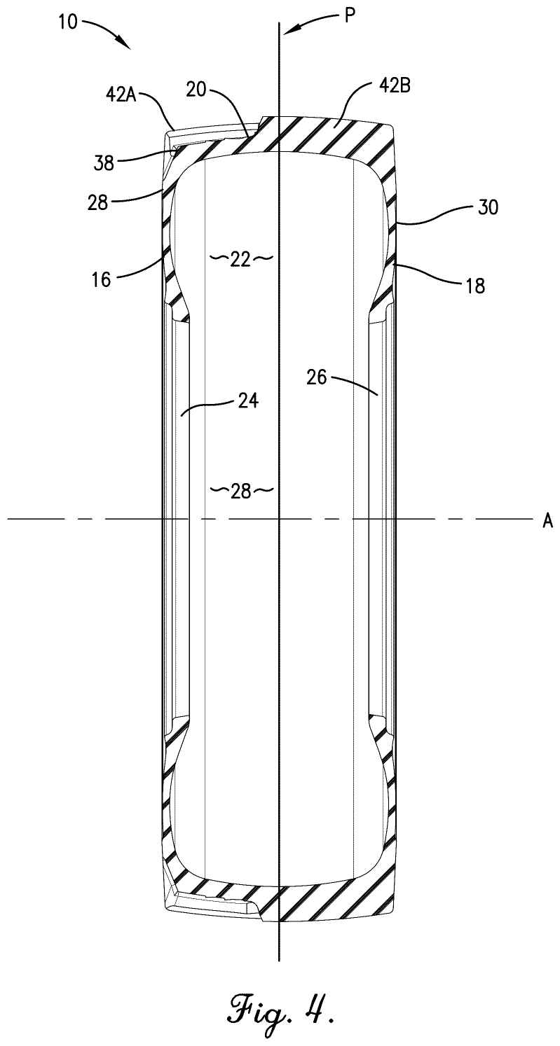

A non-directional pneumatic tire 10 constructed in accordance with embodiments of the present invention is depicted in the attached drawing figures. As best shown in FIG. 4, the tire has a rotational axis A and a central plane P extending perpendicularly through the rotational axis. As labelled in FIG. 1, the tire 10 broadly comprises a tire carcass 12 and a non-directional tread pattern 14 extending from the carcass.

The tire carcass 12 may be formed of rubber, mixtures of rubber and other compounds, or any other suitable materials or combinations of materials and comprises first and second sidewalls 16, 18 and an outer wall 20 extending radially between the first and second sidewalls. The sidewalls 16, 18 and outer wall 20 together define an internal inflation chamber 22 that may be inflated with air or any other gas. The tire carcass may have any diameter and width.

The sidewalls 16, 18 have inner circular edges 24, 26 that define a circular opening 28 for mounting the tire on a wheel or rim and outer edges 28, 30 that intersect the outer wall 20 of the tire carcass. The sidewalls may have any width or height.

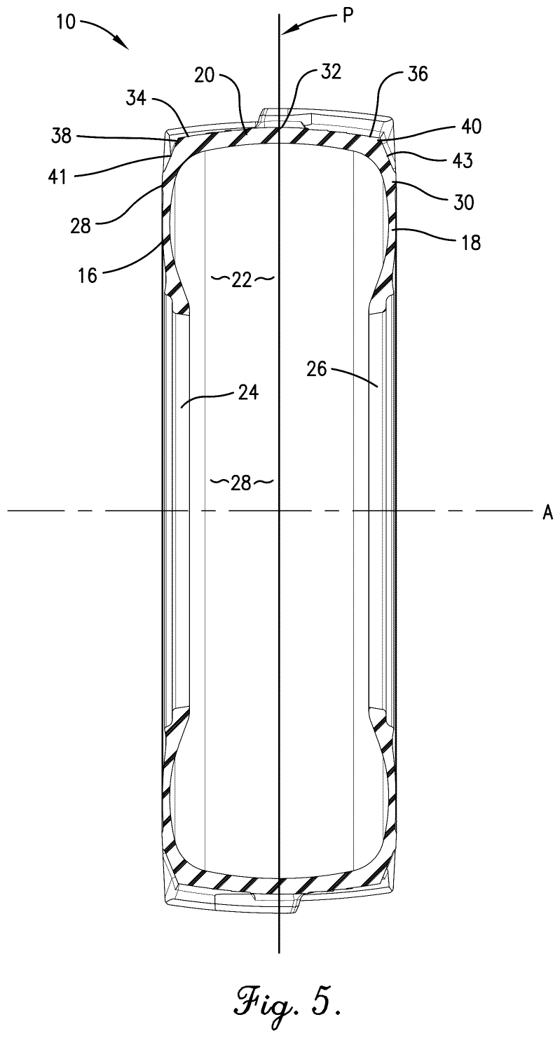

As best shown in FIG. 5 the outer wall 20 has a midpoint 32 and two side edges 34, 36 that intersect with the outer edges 28, 30 of the sidewalls 16, 18. As best shown in FIG. 1, the tire carcass presents a first transition 38 between the outer edge 28 of the first sidewall 16 and the first side edge 34 of the outer wall; and a second transition 40 between the outer edge 30 of the second sidewall 18 and the second side edge 36 of the outer wall. In accordance with an important aspect of the invention, the transitions 38, 40 are angular (sharp corners) with little curvature.

The carcass may also have substantially straight, flat segments 41, 43 between the transitions 38, 40 and the outer edges 28, 30 of the sidewalks 16, 18. In one embodiment, the angles between the side edges 34, 36 and the flat segments 41, 43 are 250-270 degrees. Applicant has discovered that the sharper transitions 38, 40 and the flat segments 41, 43 increase tire ground contact area and keep more mud within the wheel track so as to reduce rutting depth and reduce rut ridge heights. In contrast, prior art tires have curved transitions between their side walls and outer radial walls that limit their ground contact areas near the side edges of the tires, resulting in deeper ruts and higher rut ridges.

In accordance with another important aspect of the invention, the outer wall 20 of the tire carcass is relatively flat with little curvature. Specifically, as best seen in FIG. 5, the outside diameter of the midpoint 32 of the outer wall is only slightly greater than the outside diameters of the side edges 34, 36 such that the outer wall is substantially flat with little curvature from the midpoint to the side edges. Applicant has discovered that the flat profile of the tire, along with the sharper transitions 38, 40 between the sidewalls and outer wall described above, increase tire ground contact area and keep more mud within the wheel track so as to reduce rutting depth and reduce rut ridge heights. In contrast, known existing tires have outer carcass walls that curve substantially from their midpoints to their side edges resulting in deeper ruts and higher rut ridges.

In one embodiment, the outside diameter of the midpoint 32 is less than 3% greater than outside diameters of the side edges 34, 36. In another embodiment, the outside diameter of the midpoint 32 is less than 5% greater than outside diameters of the side edges 34, 36. In yet another embodiment, the outside diameter of the midpoint 32 is less than 10% greater than outside diameters of the side edges 34, 36.

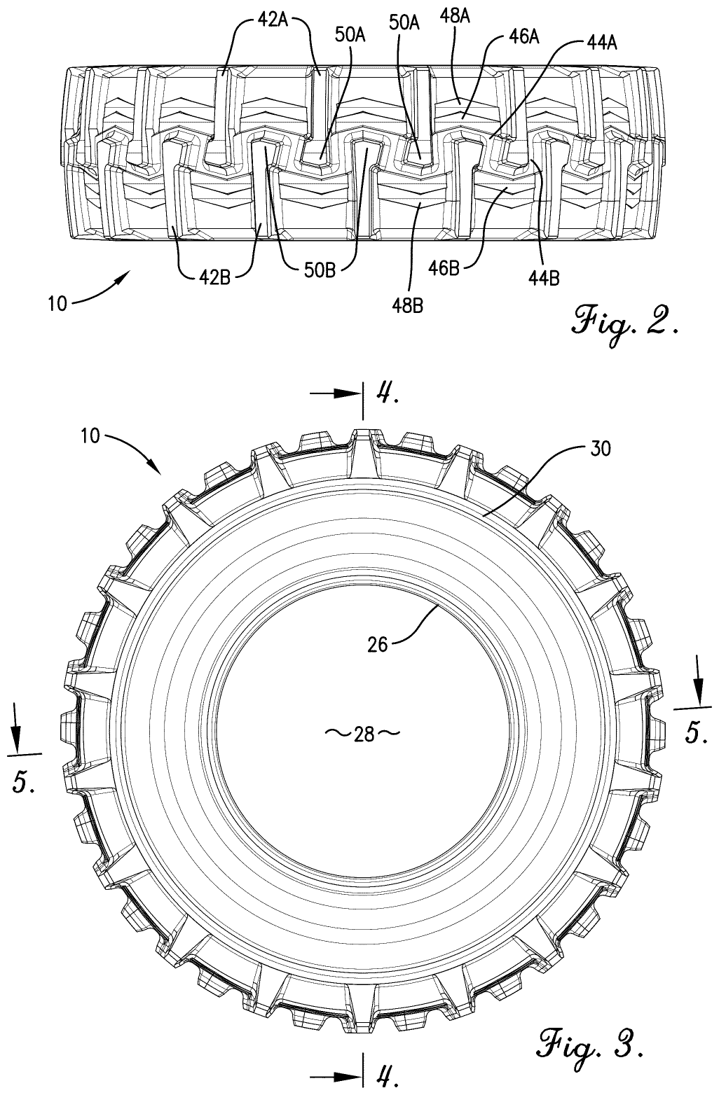

In accordance with another important aspect of the invention, the tread patterns 14 on the tire 10 are optimized for non-directional travel and mud-shedding. In one embodiment, the tread patterns comprise a number of longitudinal lugs 42A, 42B and a number of mud-shedding secondary lugs 44A, 44B, 46A, 46B, 48A, 48B as labeled in FIG. 2.

The longitudinal lugs 42A extend in a row substantially parallel to the rotational axis of the tire from the first sidewall 16 and toward and across the central plane P of the tire. The longitudinal lugs 42B extend in an opposite row substantially parallel to the rotational axis of the tire from the second sidewall 18 and toward and across the central plane P of the tire. In one embodiment, the longitudinal lugs 42A, 42B in the first and second rows circumferentially alternate so as not to touch one another.

The illustrated lugs 42A, 42B have enlarged hammer-shaped heads 50A, 50B on their distal ends. The heads 50A on the lugs 42A in the first row face in one direction and the heads 50B on the lugs 42B in the second row face in the opposite direction. In one embodiment, the longitudinal lugs 42A, 42B have a height of approximately 30-40 mm, a width of approximately 20-30 mm, a pitch of approximately, and a void ratio of approximately 16-20%.

The mud-shedding lugs 44A, 44B, 46A, 46B, 48A, 48B extend substantially perpendicular to the rotational axis of the tire. In one embodiment, three of the mud-shedding lugs are positioned between each adjacent pair of the longitudinal lugs 42A, 42B on either the right side, left side, both sides of the tire. The outside diameters of the lugs 44A, 44B, 46A, 46B, 48A, 48B are tapered from the midpoint of the tire toward the side edges. Specifically, the first mud-shedding lugs 44A, 44B, which are nearest the midpoint of the tire, have the greatest outside diameters; the second mud-shedding lugs 46A, 46B, which are between their first and third lugs, have outside diameters less than the outside diameters of the first lugs; and the third lugs 48A, 48B, which are nearest the side edges of the tire, have the smallest outside diameters. The mud-shedding lugs reduce the accumulation of mud on the tires while simultaneously keeping the shed mud in the wheel track so as to reduce rutting depth and rut ridge heights.

In one embodiment, the outside diameters of the first mud-shedding lugs 44A, 44B are 5% greater than the outside diameters of the second mud-shedding lugs 46A, 46B, and the outside diameters of the second mud-shedding lugs 46A, 46B are 5% greater than the outside diameters of the third mud-shedding lugs 48A, 48B. In another embodiment, the outside diameters of the first mud-shedding lugs 44A, 44B are 10% greater than the outside diameters of the second mud-shedding lugs 46A, 46B, and the outside diameters of the second lugs are 10% greater than the outside diameters of the third mud-shedding lugs 48A, 48B. In yet another embodiment, the outside diameters of the first mud-shedding lugs are 15% greater than the outside diameters of the second mud-shedding lugs, and the outside diameters of the second mud-shedding lugs are 15% greater than the outside diameters of the third mud-shedding lugs.

### ADDITIONAL CONSIDERATIONS

The detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The detailed description is, therefore, not to be taken in a limiting sense. The scope of the current invention is defined only by the appended claims, along with the full scope of equivalents to which such claims are entitled.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A non-directional pneumatic tire, the tire having a rotational axis and a central plane extending perpendicularly through the rotational axis at a midpoint of the tire, the tire comprising:
a carcass defining an internal inflation chamber, the carcass comprising:
first and second sidewalls;
an outer wall extending radially between the first and second sidewalls;
a first transition between the first sidewall and the outer wall;
a second transition between the second sidewall and the outer wall;
wherein the first and second transitions are angular with little curvature; and
a non-directional tread pattern extending from the outer wall of the carcass.

2. The tire of claim 1, wherein the outer wall of the carcass has a midpoint and two side edges, wherein an outside diameter of the midpoint measured from the rotational axis is no more than 5% greater than outside diameters of the side edges such that the outer wall is substantially flat with little curvature from the midpoint to the side edges.

3. The tire of claim 2, wherein the tread pattern comprises:
a first row of longitudinal lugs extending substantially parallel to the rotational axis of the tire from the first sidewall and toward and across the central plane of the tire;
a second row of longitudinal lugs extending substantially parallel to the rotational axis of the tire from the second sidewall and toward and across the central plane of the tire;
the first and second rows of longitudinal lugs circumferentially alternating so as not to touch one another.

4. The tire of claim 3, wherein the tread pattern further comprises a plurality of mud-shedding lugs between at least one adjacent pair of the first or second rows of longitudinal lugs, the mud-shedding lugs extending substantially perpendicular to the rotational axis of the tire.

5. The tire of claim 4, the plurality of mud-shedding lugs including a first mud-shedding lug nearest the midpoint of the outer wall, a second mud-shedding lug between the first mud-shedding lug and one of the side edges of the outer wall, and a third mud-shedding lug spaced between the second mud-shedding lug and the one of the side edges of the outer wall.

6. The tire of claim 5, wherein an outside diameter of the first mud-shedding lug measured from the rotational axis is greater than an outside diameter of the second mud-shedding lug.

7. The tire of claim 6, wherein an outside diameter of the second mud-shedding lug is greater than an outside diameter of the third mud-shedding lug.

8. A non-directional pneumatic tire for use on an agricultural machine, the tire comprising:
a carcass defining an internal inflation chamber, the carcass comprising:
first and second sidewalls;
an outer wall extending radially between the first and second sidewalls, wherein the outer wall has a midpoint and two side edges, wherein an outside diameter of the midpoint is less than 5% greater than outside diameters of the side edges such that the outer wall is substantially flat with little curvature from the midpoint to the side edges;
a non-directional tread pattern extending from the outer wall of the carcass.

9. The tire of claim 8, the carcass further comprising a first transition between the first sidewall and the outer wall and a second transition between the second sidewall and the outer wall; wherein the first and second transitions are angular with little curvature.

10. The tire of claim 8, wherein the tread pattern comprises:
a first row of longitudinal lugs extending substantially parallel to the rotational axis of the tire from the first sidewall and toward and across the central plane of the tire;
a second row of longitudinal lugs extending substantially parallel to the rotational axis of the tire from the second sidewall and toward and across the central plane of the tire;
the first and second rows of longitudinal lugs circumferentially alternating so as not to touch one another.

11. The tire of claim 10, wherein the tread pattern further comprises a plurality of mud-shedding lugs between at least one adjacent pair of the first or second rows of longitudinal lugs, the mud-shedding lugs extending substantially perpendicular to the rotational axis of the tire.

12. The tire of claim 11, the plurality of mud-shedding lugs including a first mud-shedding lug nearest the midpoint of the outer wall, a second mud-shedding lug between the first mud-shedding lug and one of the side edges of the outer wall, and a third mud-shedding lug spaced between the second mud-shedding lug and the one of the side edges of the outer wall.

13. The tire of claim 12, wherein an outside diameter of the first mud-shedding lug measured from the rotational axis is greater than an outside diameter of the second mud-shedding lug.

14. The tire of claim 13, wherein an outside diameter of the second mud-shedding lug is greater than an outside diameter of the third mud-shedding lug.

15. A non-directional pneumatic tire for use on an agricultural machine, the tire having a rotational axis and a central plane extending perpendicularly through the rotational axis, the tire comprising:
a tire carcass defining an internal inflation chamber, the tire carcass comprising:
first and second sidewalls; and
an outer wall extending radially between the first and second sidewalls, wherein the outer wall has a midpoint and two side edges; and
a non-directional tread pattern extending from the outer wall of the carcass, the tread pattern comprising:
a first row of longitudinal lugs extending substantially parallel to the rotational axis of the tire from the first sidewall and toward and across the central plane of the tire;
a second row of longitudinal lugs extending substantially parallel to the rotational axis of the tire from the second sidewall and toward and across the central plane of the tire;
the first and second rows of longitudinal lugs circumferentially alternating so as not to touch one another; and
a plurality of mud-shedding lugs between at least one adjacent pair of the longitudinal lugs in the first or second rows of longitudinal lugs and extending substantially perpendicular to the rotational axis of the tire.

16. The tire of claim 15, the plurality of mud-shedding lugs including a first mud-shedding lug nearest the midpoint of the outer wall, a second mud-shedding lug spaced between the first mud-shedding lug and one of the side edges of the outer wall, and a third mud-shedding lug spaced between the second mud-shedding lug and one of the side edges of the outer wall.

17. The tire of claim 16, wherein an outside diameter of the first mud-shedding lug measured from the rotational axis is greater than an outside diameter of the second mud-shedding lug.

18. The tire of claim 17, wherein an outside diameter of the second mud-shedding lug is greater than an outside diameter of the third mud-shedding lug.

19. The tire of claim 15, the tire carcass further comprising:
a first transition between the first sidewall and the outer wall; and
a second transition between the second sidewall and the outer wall.

20. The tire of claim 19, wherein the first and second transitions are angular with little curvature.
